(19) United States
(12) Patent Application Publication
(10) Pub. No.: US 2012/0204661 A1
(43) Pub. Date: Aug. 16, 2012

(54) Fixed Moment Arm Internal Gear Drive Apparatus

(75) Inventor: William James Carr, San Jose, CA (US)

(73) Assignee: CNG-DESIGN. LLC

(21) Appl. No.: 13/025,773

(22) Filed: Feb. 11, 2011

(51) Int. Cl. F16H 25/08

(52) U.S. Cl. 74/25

(57) ABSTRACT

An apparatus for converting linear reciprocal motion to rotary motion, comprising a reciprocating component and a reciprocating rod capable of linear reciprocal motion in unison, internal gear racks, a segmented gear, and transfer plates is provided. The internal gear racks are disposed on opposing internal sides of the reciprocating rod for inducing rotary motion in the segmented gear by linear reciprocal motion of the reciprocating rod. The segmented gear, disposed within a space defined between the opposing internal sides of the reciprocating rod and rigidly connected to a power shaft, alternately meshes with the internal gear racks to transmit rotary motion to the power shaft. The transfer plates, coaxially disposed on the segmented gear's centric axis, comprise profiled grooves for controlling transition of the reciprocating rod by contacting the reciprocating rod, when the reciprocating component is at a top dead center and a bottom dead center within an engine housing.

### BACKGROUND

Conventional reciprocating engines consist of a cylinder body and a piston with a connecting rod and a crank assembly. During operation of a conventional reciprocating engine, the connecting rod and the crank assembly convert linear reciprocal motion to rotary motion. A mixture of fuel and air is ignited in the cylinder body and a combustion force is produced as a result of the ignition of the mixture of fuel and air. The piston executes linear reciprocal motion in response to the combustion force. The connecting rod is displaced along a vertical plane when the piston executes the linear reciprocal motion. This displacement of the connecting rod angularly displaces the combustion force while transmitting the combustion force to the crank assembly. The angular displacement of the combustion force varies with respect to the position of the piston in the cylinder body. Thus, a variable moment arm exists and subsequently a constantly varying component of the combustion force is transmitted to the crank assembly over a cycle of operation of the conventional reciprocating engine. The displacement of the connecting rod allows only a component of the combustion force to be transmitted to the crank assembly and hence results in wastage of energy and high fuel consumption for a rated power output.

Consider a conventional reciprocating engine with a fixed stroke length, for example, a two-inch stroke length. The length of the variable moment arm, approximately averaging 0.333-inch moment arm for a two-inch stroke length, would be a varying one, for example, 0 inch to 1 inch, at different instants of operation. A 2″ stroke average moment arm for the crank/piston relationship is 0.333″. This is achieved by taking the moment arm at the start, which is 0, the moment arm at the middle, which is 1, and the moment arm at the finish, which is 0. On adding these moment arms together and dividing by three, the average moment arm is 0.333″. The moment arm here is a variable moment arm due to its varying length, that is, 0 inch to 1 inch. Hence, the varying length of the variable moment arm in a conventional reciprocating engine allows only a component of the combustion force to be transmitted to an output shaft via the crank assembly due to the pivotal arrangement of the connecting rod and the crank assembly.

Furthermore, as the connecting rod reciprocates there is a tendency for the connecting rod to lose a part of its energy to frictional losses in every stroke that the connecting rod undertakes. Prolonged use of the connecting rod without the use of external fixtures results in wear and tear of the material of the connecting rod. Hence, there is a need for an apparatus that facilitates smooth frictionless movement of the connecting rod during each stroke, which in turn facilitates smooth transfer of power from the connecting rod to an output shaft. Moreover, in a geared system, the inability to control the connecting rod causes misalignment and locking of mating gears which affects the working of the engine. Hence, there is a need for a mechanism that facilitates soft engagement of the mating gears and prevents any misalignment between the gears during the working of the engine.

Hence, there is a long felt but unresolved need for a fixed moment arm internal gear drive apparatus that converts linear reciprocal motion to rotary motion, recovers a part of the wasted energy, and uses the recovered energy to drive a power shaft. Furthermore, there is a need for controlling transition of the connecting rod to enable smooth frictionless movement of the connecting rod.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The fixed moment arm internal gear drive apparatus disclosed herein addresses the above stated need for converting linear reciprocal motion to rotary motion by eliminating and replacing a crank assembly with a fixed moment arm. This is achieved by means of a fixed moment arm orientation between an internal gear rack of a reciprocating rod and a segmented gear that is in alternate mesh with the internal gear rack of the reciprocating rod, in which the combustion force is always perpendicular to the surface on which the combustion force is transmitted. Therefore, the apparatus disclosed herein, with the fixed moment arm orientation between the internal gear rack of the reciprocating rod and the segmented gear, possesses an inherent advantage over conventional reciprocating engines. The reciprocating rod of the apparatus disclosed herein transmits all or most part of the combustion force into driving the segmented gear. Furthermore, the apparatus disclosed herein has a larger effective moment arm compared to a conventional reciprocating engine. In operation, the apparatus disclosed herein inherently eliminates the presence of angularity while transmitting the combustion force from the reciprocating rod to the segmented gear, and also transmits the combustion force perpendicularly from the reciprocating rod to the segmented gear at all times. The apparatus disclosed herein recovers a part of the wasted energy and uses the recovered energy to drive a power shaft.

The fixed moment arm internal gear drive apparatus disclosed herein comprises at least one reciprocating assembly comprising a reciprocating component and a reciprocating rod, multiple internal gear racks, a segmented gear, and one or more transfer plates. The reciprocating component and the reciprocating rod are capable of linear reciprocal motion in unison. The reciprocating component is, for example, a piston. The reciprocating component is rigidly attached to the reciprocating rod along a vertical axis of the reciprocating rod. The reciprocating component is supported in an engine housing. The reciprocating rod comprises an elongated aperture along the vertical axis of the reciprocating rod. The elongated aperture defines a space between opposing internal sides of the reciprocating rod for accommodating the segmented gear.

The internal gear racks are disposed on the opposing internal sides of the reciprocating rod for inducing torque and hence rotary motion in the segmented gear by the linear reciprocal motion of the reciprocating rod. Each of the internal gear racks is integrated on the opposing internal sides of the reciprocating rod or internally attached to the opposing internal sides of the reciprocating rod. The segmented gear is in alternate mesh with the internal gear racks rigidly attached on the opposing internal sides of the reciprocating rod. The internal gear racks of the reciprocating rod and the segmented gear are constructed, for example, in a spur gear configuration, a helical gear configuration, a herringbone gear configuration, etc.

The segmented gear is disposed within a space defined between the opposing internal sides of the reciprocating rod. The segmented gear is rigidly connected to a power shaft. The power shaft is rotatably supported in the engine housing. The centric axis of the segmented gear is collinear to a longitudinal axis of the power shaft during operation of the apparatus. The segmented gear comprises a partial gear area on a surface of the segmented gear. The partial gear area on the surface of the segmented gear is in alternate mesh with one of the internal gear racks on one of the opposing internal sides of the reciprocating rod. The segmented gear alternately meshes with the internal gear racks on the opposing internal sides of the reciprocating rod to transmit the rotary motion of the segmented gear to the power shaft. The segmented gear and each of the internal gear racks together define a fixed moment arm.

The transfer plates are coaxially disposed on a centric axis of the segmented gear and rigidly connected to the power shaft. The transfer plates are rigidly connected and timed to the segmented gear. Each of the transfer plates comprises one or more profiled grooves for controlling transition of the reciprocating rod by contacting the reciprocating rod, when the reciprocating component is at the top dead center and the bottom dead center within the engine housing to enable smooth frictionless movement of the reciprocating rod. The segmented gear transmits the rotary motion to the transfer plates for rotating the transfer plates.

The transfer plates receive power from the segmented gear. The transfer plates, rigidly connected and timed to the segmented gear, assist and facilitate smooth alternate meshing of the segmented gear with the internal gear racks of the reciprocating rod. The transfer plates further comprise one or more balancing reliefs defined along a circumference of the transfer plates for stabilizing the transfer plates.

The apparatus disclosed herein further comprises one or more followers rigidly connected to the opposing ends of the reciprocating rod for following the rotary motion of the transfer plates. The followers rotatably contact the profiled grooves of the transfer plates, when the reciprocating component is at the top dead center and the bottom dead center within the engine housing. The profiled grooves of the transfer plates comprise curvedly shaped walls for contacting the followers rigidly connected to the opposing ends of the reciprocating rod, when the reciprocating component is at the top dead center and the bottom dead center within the engine housing.

In an embodiment, a keyway is defined on an inner periphery of a central opening of each of the segmented gear and the transfer plates. The power shaft is inserted into the central opening of each of said segmented gear and the transfer plates, and locked to the segmented gear and the transfer plates through the keyway. The rotary motion of the segmented gear rotates the power shaft rigidly connected to the segmented gear via the rotating transfer plates. The rotary motion of the segmented gear thereby converts the linear reciprocal motion of the reciprocating assembly to the rotary motion of the power shaft.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific components and methods disclosed herein.

FIG. 1 exemplarily illustrates a perspective view of a fixed moment arm internal gear drive apparatus for converting linear reciprocal motion to rotary motion.

FIG. 2 exemplarily illustrates an exploded view of the fixed moment arm internal gear drive apparatus.

FIG. 3 exemplarily illustrates an assembled perspective view of the fixed moment arm internal gear drive apparatus.

FIG. 4 exemplarily illustrates an isometric view of a reciprocating rod of the fixed moment arm internal gear drive apparatus, supported in a rod housing.

FIG. 5 exemplarily illustrates an exploded view of the reciprocating rod.

FIG. 6A exemplarily illustrates a front orthogonal view of one of the transfer plates of the fixed moment arm internal gear drive apparatus.

FIG. 6B exemplarily illustrates a side orthogonal view of one of the transfer plates of the fixed moment arm internal gear drive apparatus.

FIG. 7 exemplarily illustrates a sectional view of an engine housing incorporated with the fixed moment arm internal gear drive apparatus.

FIG. 8 exemplarily illustrates an isometric view of an inline engine incorporated with multiple fixed moment arm internal gear drive apparatuses.

FIG. 9A exemplarily illustrates an orthogonal view of the fixed moment arm internal gear drive apparatus, when a reciprocating component is at a bottom dead center within the engine housing.

FIG. 9B exemplarily illustrates a perspective view of the fixed moment arm internal gear drive apparatus, when the reciprocating component is at the bottom dead center within the engine housing.

FIG. 10 exemplarily illustrates an orthogonal view of the fixed moment arm internal gear drive apparatus, when the reciprocating component is traversing from the bottom dead center to a top dead center within the engine housing.

FIG. 11A exemplarily illustrates an orthogonal view of the fixed moment arm internal gear drive apparatus, when the reciprocating component is at the top dead center within the engine housing.

FIG. 11B exemplarily illustrates a perspective view of the fixed moment arm internal gear drive apparatus, when the reciprocating component is at the top dead center within the engine housing.

FIG. 12 exemplarily illustrates an orthogonal view of the fixed moment arm internal gear drive apparatus, when the reciprocating component is traversing from the top dead center to the bottom dead center within the engine housing.

FIG. 13 exemplarily illustrates an orthogonal view of the fixed moment arm internal gear drive apparatus, when the reciprocating component is at the bottom dead center within the engine housing.

FIG. 14 illustrates a method for converting linear reciprocal motion to rotary motion.

### DETAILED DESCRIPTION OF THE INVENTION

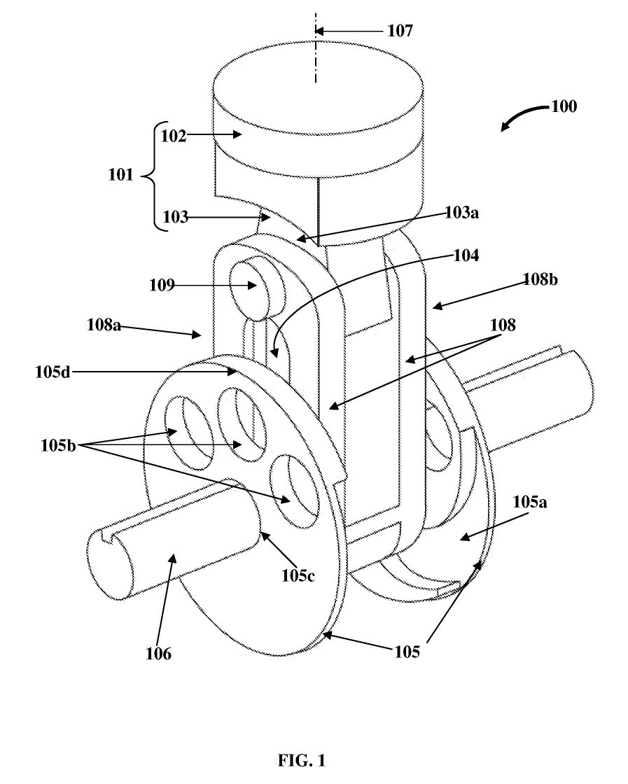

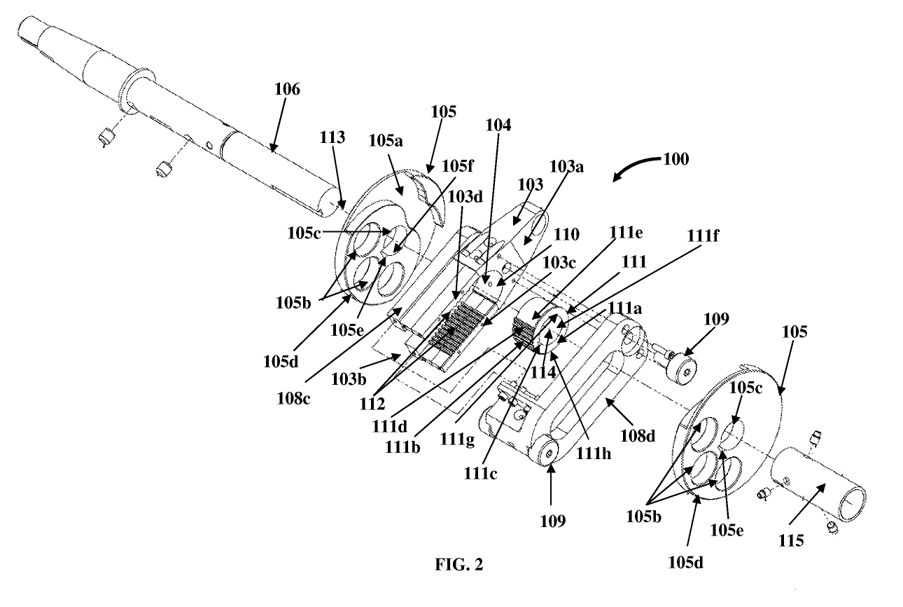

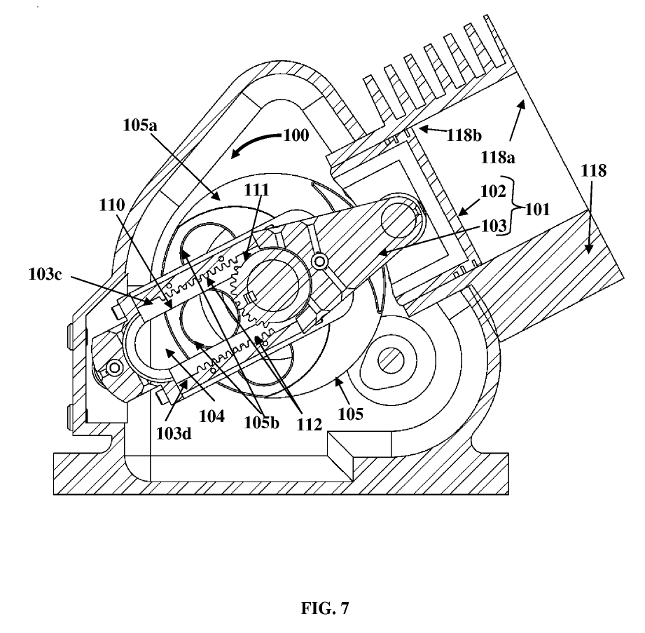

FIG. 1 exemplarily illustrates a perspective view of a fixed moment arm internal gear drive apparatus 100 for converting linear reciprocal motion to rotary motion. The fixed moment arm internal gear drive apparatus 100 disclosed herein comprises at least one reciprocating assembly 101, multiple internal gear racks 112, a segmented gear 111, and one or more transfer plates 105 as exemplarily illustrated in FIG. 2 and FIG. 7. The reciprocating assembly 101 comprises a reciprocating component 102 and a reciprocating rod 103 capable of linear reciprocal motion in unison. The reciprocating component 102 is a piston 102. The reciprocating component 102 is supported in an engine housing 118 as exemplarily illustrated in FIG. 7. The reciprocating component 102 is rigidly attached to the reciprocating rod 103 along a vertical axis 107 of the reciprocating rod 103. The reciprocating rod 103 is enclosed and supported by a rod housing 108. The reciprocating rod 103 comprises an elongated aperture 110 along the vertical axis 107 of the reciprocating rod 103. The elongated aperture 110 defines a space 104 between opposing internal sides 103c and 103d of the reciprocating rod 103 for accommodating the segmented gear 111 as exemplarily illustrated in FIG. 7.

One or more transfer plates 105 are coaxially disposed on a centric axis 114 of the segmented gear 111, as exemplarily illustrated in FIG. 2, and rigidly connected to a power shaft 106. In an embodiment, the transfer plates 105 are positioned on opposing sides 108a and 108b of the rod housing 108 that supports the reciprocating rod 103. The fixed moment arm internal gear drive apparatus 100 disclosed herein further comprises one or more followers 109 rigidly connected to the opposing ends 103a and 103b of the reciprocating rod 103 through the rod housing 108 are disclosed in the detailed description of FIG. 2.

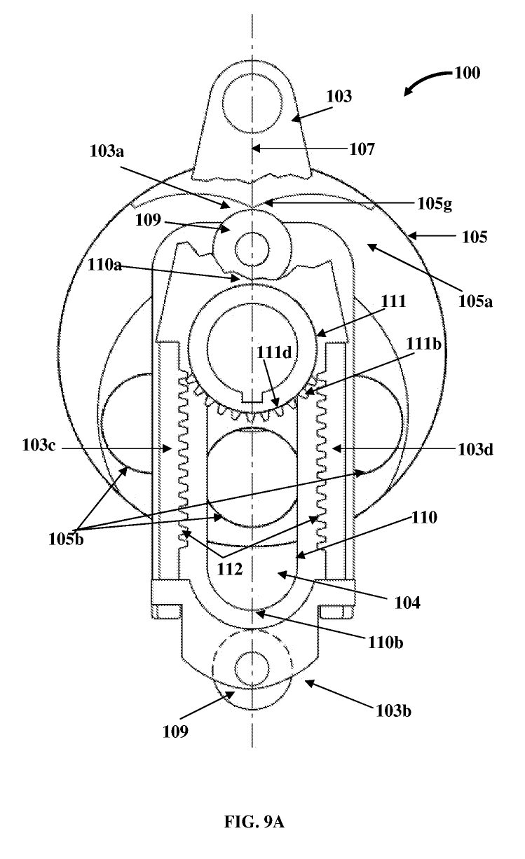

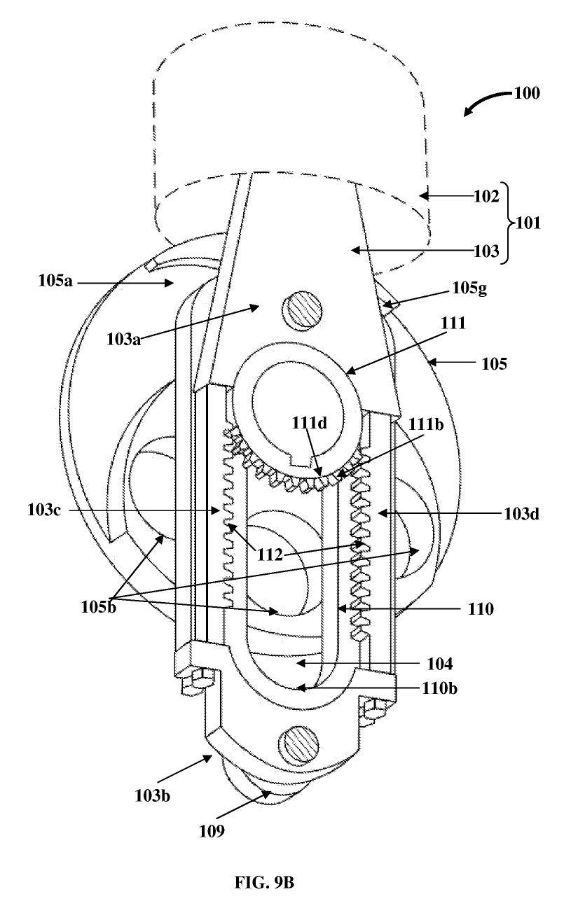

Each of the transfer plates 105 comprises one or more profiled grooves 105a for controlling transition of the reciprocating rod 103 by contacting the reciprocating rod 103, when the reciprocating component 102 is at the top dead center 118a and the bottom dead center 118b within the engine housing 118 as disclosed in the detailed descriptions of FIGS. 9A-9B, FIG. 10, FIGS. 11A-11B, and FIGS. 12-13. As used herein, the term “top dead center” refers to a location of the reciprocating component 102 at its uppermost point of reciprocal travel relative to a cylinder in an engine housing 118 and is a point at which the reciprocating component 102 is at a dead stop or zero velocity. Correspondingly, the term “bottom dead center” refers to a location of the reciprocating component 102 at its lowermost point of reciprocal travel relative to the cylinder and is also a point at which the reciprocating component 102 is at a dead stop or zero velocity.

Each of the transfer plates 105 further comprises one or more balancing reliefs 105b defined along a circumference 105d of the transfer plates 105 for stabilizing the transfer plates 105. The balancing reliefs 105b are, for example, openings drilled in the transfer plates 105 that stabilize the transfer plates 105 while the transfer plates 105 are rotating. The balancing reliefs 105b on the transfer plates 105 cause the transfer plates 105 to rotate at a constant angular moment leading to a stabilized rotation of the transfer plates 105.

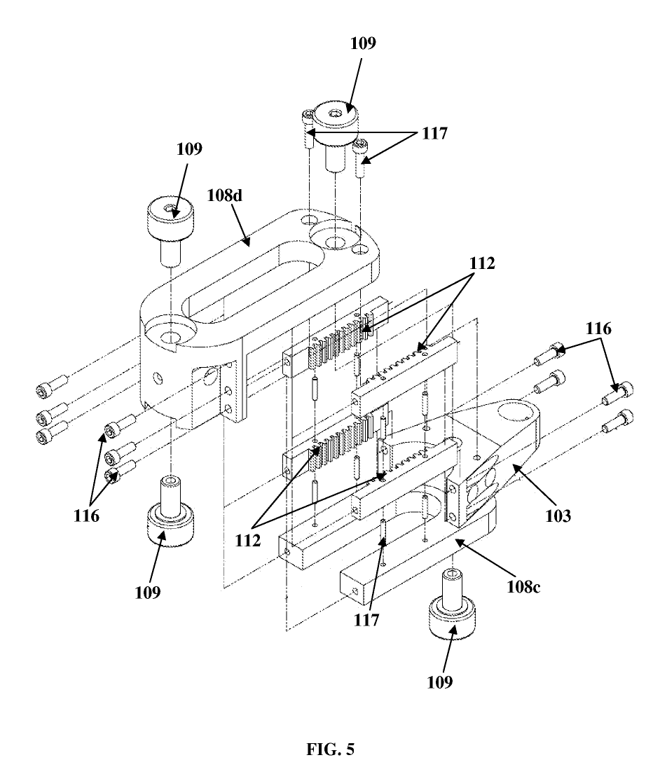

FIG. 2 exemplarily illustrates an exploded view of the fixed moment arm internal gear drive apparatus 100. FIG. 2 shows the reciprocating rod 103, the rod housing 108 that supports the reciprocating rod 103, the segmented gear 111, the transfer plates 105, and the power shaft 106. Multiple internal gear racks 112 are disposed on the opposing internal sides 103c and 103d of the reciprocating rod 103 for inducing rotary motion in the segmented gear 111 by the linear reciprocal motion of the reciprocating rod 103. Each of the internal gear racks 112 is a linear gearing element that converts the linear reciprocal motion of the reciprocating rod 103 to a rotary motion of the segmented gear 111, on engagement of the segmented gear 111 with the internal gear racks 112. The internal gear racks 112 are made, for example, by forging, casting, machining, etc. Each of the internal gear racks 112 is integrated on the opposing internal sides 103c and 103d of the reciprocating rod 103 or internally attached to the opposing internal sides 103c and 103d of the reciprocating rod 103, for example, using fasteners 116 as exemplarily illustrated in FIG. 5.

The segmented gear 111 is a pinion having a cam 111a and gear teeth 111b that produces a smooth reciprocating motion. The segmented gear 111 is disposed within the space 104 defined between the opposing internal sides 103c and 103d of the reciprocating rod 103 and is rigidly connected to the power shaft 106. The segmented gear 111 comprises a partial gear area 111d on a surface 111e of the segmented gear 111. The partial gear area 111d on the surface 111e of the segmented gear 111 having the gear teeth 111b is in alternate mesh with one of the internal gear racks 112 on one of the opposing internal sides 103c and 103d of the reciprocating rod 103. As used herein, the term “alternate mesh” refers to an alternation in meshing of the partial gear area 111d of the segmented gear 111 having the gear teeth 111b with the internal gear racks 112 on one opposing internal side 103c of the reciprocating rod 103 to the other opposing internal side 103d of the reciprocating rod 103. The gear teeth 111b on the partial gear area 111d of the segmented gear 111 alternately engages with the internal gear racks 112, thereby causing rotation of the segmented gear 111 when the reciprocating rod 103 undergoes linear reciprocal motion.

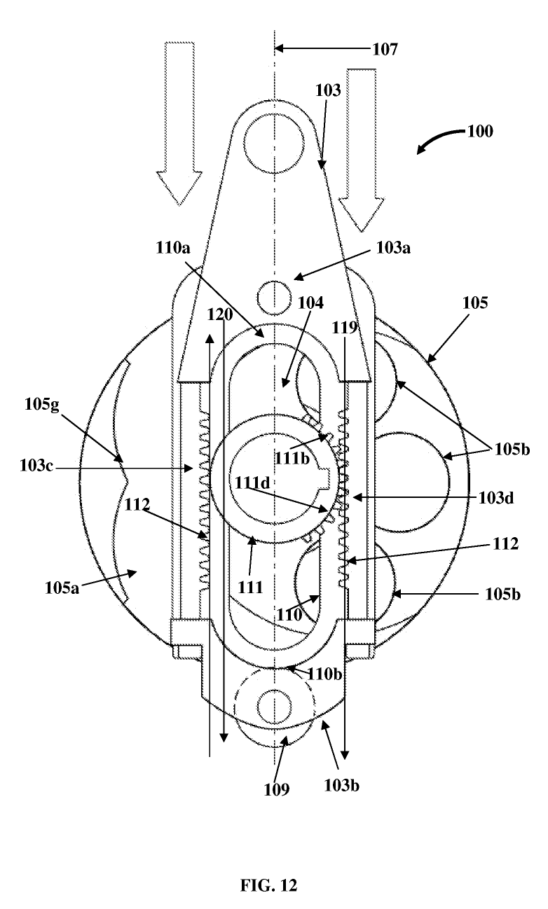

The segmented gear 111 further comprises a central opening 111f and a keyway 111c defined on an inner periphery 111g of the central opening 111f of the segmented gear 111. The keyway 111c of the segmented gear 111 enables locking of the power shaft 106 to the segmented gear 111. The segmented gear 111 alternately meshes with the internal gear racks 112 on the opposing internal sides 103c and 103d of the reciprocating rod 103 to transmit the rotary motion of the segmented gear 111 to the power shaft 106. The segmented gear 111 and each of the internal gear racks 112 together define a fixed moment arm 119 as disclosed in the detailed description of FIG. 12. The internal gear racks 112 of the reciprocating rod 103 and the segmented gear 111 are constructed, for example, in a spur gear configuration, a helical gear configuration, a herringbone gear configuration, etc.

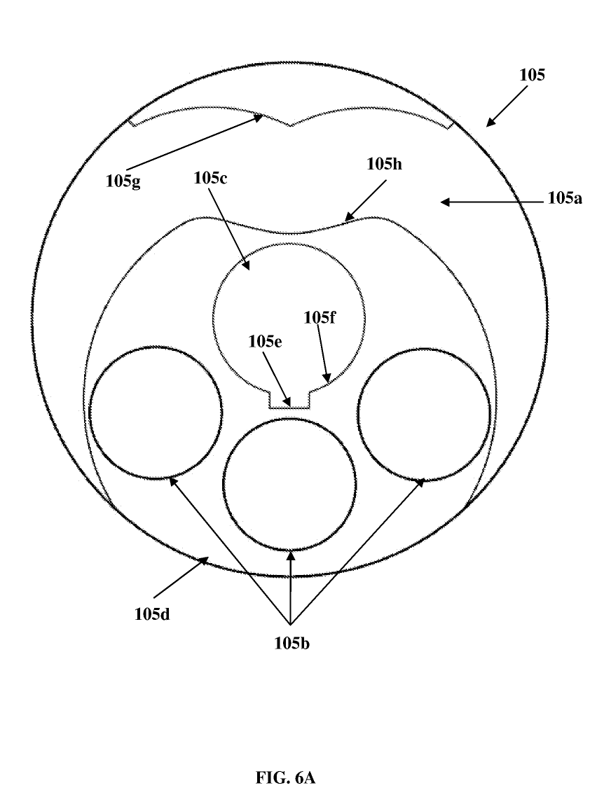

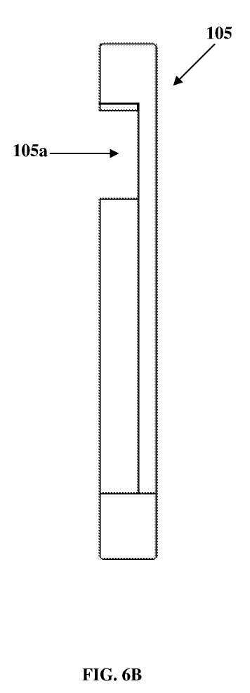

The transfer plates 105 are coaxially disposed on the centric axis 114 of the segmented gear 111 and rigidly connected to the segmented gear 111 and the power shaft 106. Each of the transfer plates 105 is, for example, a cam plate that transforms rotary motion into linear motion and vice versa. The centric axis 114 of the segmented gear 111 is collinear to a longitudinal axis 113 of the power shaft 106. The segmented gear 111 transmits its rotary motion to the transfer plates 105 for rotating the transfer plates 105. Each of the transfer plates 105 further comprises a central opening 105c and a keyway 105e defined on an inner periphery 105f of the central opening 105c as disclosed in the detailed description of FIG. 6A.

The followers 109 of the fixed moment arm internal gear drive apparatus 100 are rigidly connected to the opposing ends 103a and 103b of the reciprocating rod 103 through the rod housing 108 for following the rotary motion of the transfer plates 105. The rod housing 108 comprises supporting elements 108c and 108d that enclose the reciprocating rod 103. The followers 109 rotatably contact the profiled grooves 105a of the transfer plates 105, when the reciprocating component 102 is at the top dead center 118a and the bottom dead center 118b of the engine housing 118. An adapter 115 is rotatably connected to the power shaft 106 along the longitudinal axis 113 of the power shaft 106. The adapter 115 is used for enhancing oil seal life of the power shaft 106 during lubrication.

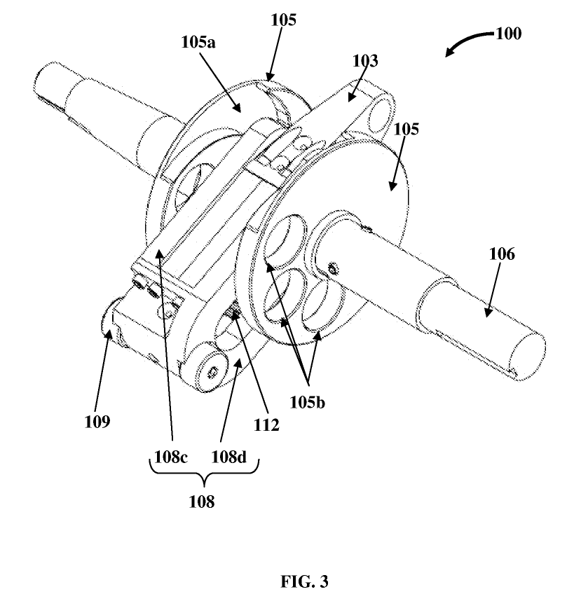

FIG. 3 exemplarily illustrates an assembled perspective view of the fixed moment arm internal gear drive apparatus 100. The power shaft 106 is inserted into the central openings 111f and 105c of the segmented gear 111 and the transfer plates 105 respectively and locked to the segmented gear 111 and the transfer plates 105 through the keyways 111c and 105e respectively as exemplarily illustrated in FIG. 2. The fixed moment arm internal gear drive apparatus 100 disclosed herein is used, for example, in aircrafts, trains, buses, trucks, cars, motorcycles, lawnmowers, pumps, motors, generators, other engine driven devices, etc.

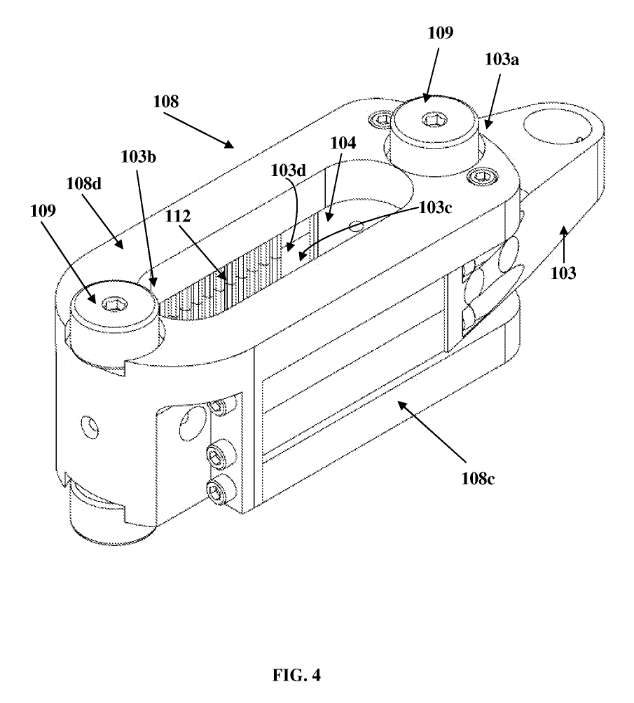

FIG. 4 exemplarily illustrates an isometric view of the reciprocating rod 103 of the fixed moment arm internal gear drive apparatus 100, supported in the rod housing 108. The reciprocating rod 103 is positioned between and is enclosed by the supporting elements 108c and 108d of the rod housing 108. The elongated aperture 110 of the reciprocating rod 103 defines a space 104 between the opposing internal sides 103c and 103d of the reciprocating rod 103 for accommodating the segmented gear 111. One or more followers 109 are rigidly connected to the opposing ends 103a and 103b of the reciprocating rod 103 through the rod housing 108 for following the rotary motion of the transfer plates 105. For example, a follower 109 is connected to the reciprocating rod 103 through each of the supporting elements 108c and 108d of the rod housing 108. The follower 109 is, for example, a cam follower. The follower 109 is a rotating component used to transform rotary motion to a reciprocal motion, or a reciprocal motion to a rotary motion. Multiple internal gear racks 112 are disposed on the opposing internal sides 103c and 103d of the reciprocating rod 103.

FIG. 5 exemplarily illustrates an exploded view of the reciprocating rod 103 supported in the rod housing 108. As exemplarily illustrated in FIG. 5, about two internal gear racks 112 are rigidly attached on each of the opposing internal sides 103c and 103d of the reciprocating rod 103, for example, using fasteners 116. The fasteners 116 lock the internal gear racks 112 to the reciprocating rod 103. The supporting elements 108c and 108d of the rod housing 108 are connected to the reciprocating rod 103 via the followers 109 and fasteners 117.

FIG. 6A and FIG. 6B exemplarily illustrate a front orthogonal view and a side orthogonal view of one of the transfer plates 105 of the fixed moment arm internal gear drive apparatus 100 respectively. The transfer plates 105 assist in alternate meshing of the segmented gear 111 with the internal gear racks 112 of the reciprocating rod 103. The transfer plates 105 control, for example, about 21 degrees of rotation of the power shaft 106, when the reciprocating component 102 is at the top dead center 118a or the bottom dead center 118b of the engine housing 118. One or more followers 109 are rigidly connected to the opposing ends 103a and 103b of the reciprocating rod 103 for following the rotary motion of the transfer plates 105. The profiled grooves 105a of each of the transfer plates 105 comprise curvedly shaped walls 105g and 105h for contacting the followers 109 rigidly connected to the opposing ends 103a and 103b of the reciprocating rod 103, when the reciprocating component 102 is at the top dead center 118a and the bottom dead center 118b within the engine housing 118. Each of the transfer plates 105 comprises a keyway 105e defined on an inner periphery 105f of the central opening 105c. The keyway 105e locks each of the transfer plates 105 to the power shaft 106. The power shaft 106 is rotatably supported in the engine housing 118.

A 21 degree of rotation of the segmented gear 111 and the power shaft 106 while the reciprocating component 102 is at the top dead center 118a and the bottom dead center 118b of the engine housing 118, translates to a total of 42 degrees at both the dead centers 118a and 118b. The remaining 318 degrees of rotation of the power shaft 106 is accomplished by the timed segmented gear 111 rigidly connected to the power shaft 106. The segmented gear 111 reacts by alternately meshing with the internal gear racks 112 rigidly attached on the opposing internal sides 103c and 103d of the reciprocating rod 103. The transfer plates 105 are rigidly connected and timed to the segmented gear 111. As disclosed herein, the term “timed” refers to synchronization of the transfer plates 105 with the segmented gear 111 for ensuring precise movement of the segmented gear 111 and the transfer plates 105.

The transfer plates 105 control the movement of the reciprocating rod 103 for 21 degrees, that is 10.5 degrees to the right of the vertical axis 107 and 10.5 degrees to the left of the vertical axis 107, when the reciprocating component 102 is at the top dead center 118a and the bottom dead center 118b within the engine housing 118. As the transfer plates 105 rotate, the transfer plates 105 slowly transfer control to the segmented gear 111 rigidly connected to the power shaft 106, thereby creating a soft gear engagement. The transfer plates 105 thereby facilitate smooth alternate meshing between the segmented gear 111 and the internal gear racks 112 of the reciprocating rod 103. The keyway 105e in the central opening 105c of each of the transfer plates 105 enables locking of each of the transfer plates 105 to the power shaft 106. Locking is performed to enable continuous transfer of torque from the segmented gear 111 to the power shaft 106 and to hold the power shaft 106 and the transfer plates 105 together. One or more balancing reliefs 105b are defined along the circumference 105d of each of the transfer plates 105 for stabilizing the transfer plates 105.

FIG. 7 exemplarily illustrates a sectional view of an engine housing 118 incorporated with the fixed moment arm internal gear drive apparatus 100. During operation of an engine, a mixture of fuel and air is ignited when the reciprocating component 102 is at the top dead center 118a of the engine housing 118. The reciprocating component 102, herein referred to as a “piston” exhibits a linear reciprocal motion. The reciprocating rod 103 rigidly attached to the piston 102 consequently exhibits the linear reciprocal motion along with the piston 102. The internal gear racks 112 rigidly attached on the opposing internal sides 103c and 103d of the reciprocating rod 103 transmit the linear reciprocal motion to the segmented gear 111. The segmented gear 111 is in alternate mesh with the internal gear racks 112 on the opposing internal sides 103c and 103d of the reciprocating rod 103. The segmented gear 111 converts the linear reciprocal motion into a rotary motion and transmits this rotary motion to the power shaft 106. The power shaft 106 is rotatably supported in the engine housing 118. A pair of transfer plates 105 disposed on the centric axis 114 of the segmented gear 111 take the load while the piston 102 is transitioning from the top dead center 118a to the bottom dead center 118b of the engine housing 118 and vice versa. In this manner, the rotary motion of the segmented gear 111 converts the linear reciprocal motion of the reciprocating assembly 101 comprising the reciprocating rod 103 and the piston 102 to rotary motion of the power shaft 106.

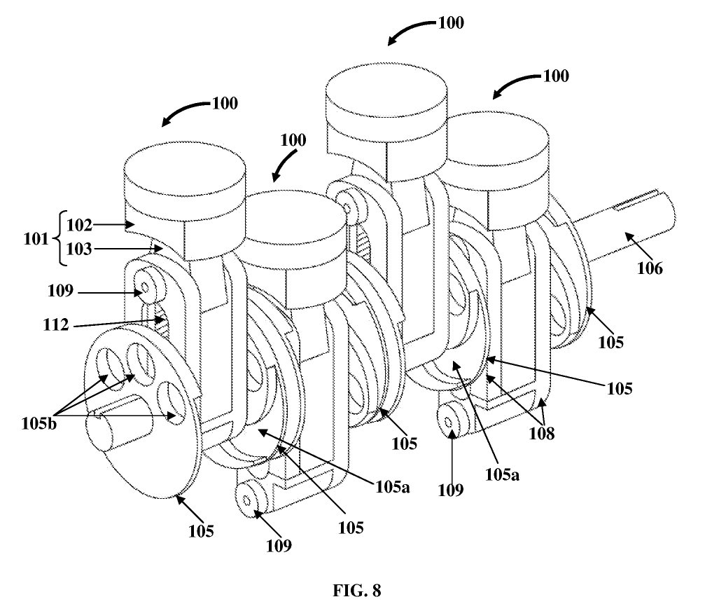

FIG. 8 exemplarily illustrates an isometric view of an inline engine incorporated with multiple fixed moment arm internal gear drive apparatuses 100. In the inline engine, multiple fixed moment arm internal gear drive apparatuses 100 are mounted on the power shaft 106 with no offset and operate to rotate the power shaft 106. The inline engine with the fixed moment arm internal gear drive apparatuses 100 can be used, for example, in automobiles, locomotives, aircrafts, etc. Inline engines are compact, easier to build, and assemble.

FIG. 9A and FIG. 9B exemplarily illustrate an orthogonal view and a perspective view of the fixed moment arm internal gear drive apparatus 100 respectively, when the reciprocating component 102 herein referred to as the “piston” is at a bottom dead center 118b within the engine housing 118. The segmented gear 111 is disposed within the space 104 defined by the elongated aperture 110 between the opposing internal sides 103c and 103d of the reciprocating rod 103. When the piston 102 is at the bottom dead center 118b, the segmented gear 111 is at the top end 110a of the elongated aperture 110 of the reciprocating rod 103. The profiled grooves 105a of the transfer plates 105 contact the followers 109 rigidly connected to the opposing ends 103a and 103b of the reciprocating rod 103, when the piston 102 is at the bottom dead center 118b as exemplarily illustrated in FIG. 9A. The segmented gear 111 transmits the rotary motion induced by the linear reciprocal motion of the reciprocating rod 103 to the transfer plates 105 for rotating the transfer plates 105. One of the followers 109 at one opposing end 103a of the reciprocating rod 103 rotatably contacts a first curvedly shaped wall 105g and a second curvedly shaped wall 105h of the profiled grooves 105a of the transfer plates 105, when the piston 102 is at the bottom dead center 118b to control transition of the reciprocating assembly 101.

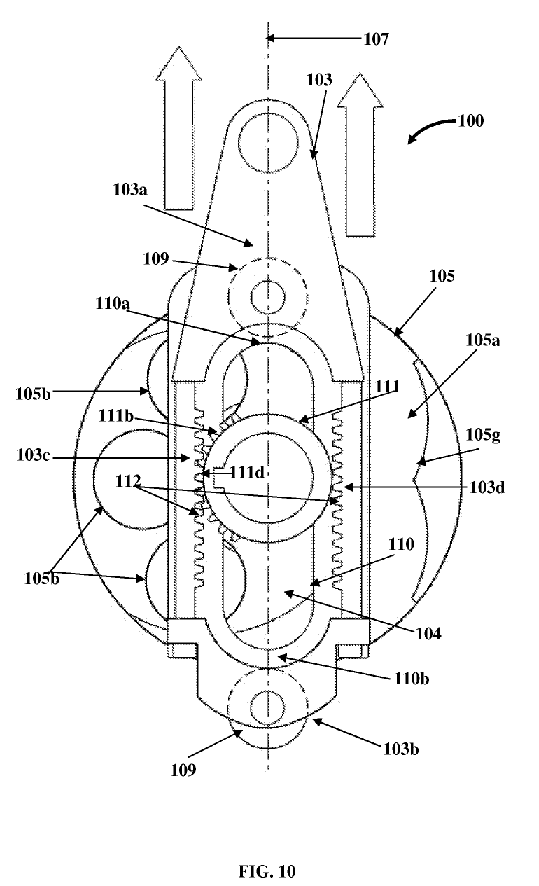

FIG. 10 exemplarily illustrates an orthogonal view of the fixed moment arm internal gear drive apparatus 100, when the piston 102 is traversing from the bottom dead center 118b to the top dead center 118a within the engine housing 118. During the compression stroke of an engine, the piston 102 traverses from the bottom dead center 118b to the top dead center 118a. The movement of the piston 102 from the bottom dead center 118b to the top dead center 118a converts the linear reciprocating motion of the reciprocating rod 103 to rotary motion of the segmented gear 111. The gear teeth 111b on the partial gear area 111d of the segmented gear 111 meshes with the internal gear racks 112 rigidly attached on one opposing internal side 103c of the reciprocating rod 103 to transmit the rotary motion of the segmented gear 111 to the power shaft 106. The segmented gear 111 transmits the rotary motion to the transfer plates 105 for rotating the transfer plates 105. The followers 109 along with the transfer plates 105 controls the movement of the reciprocating rod 103 for approximately 21 degrees at the top dead center 118a and the bottom dead center 118b. The segmented gear 111 and each of the internal gear racks 112 together define a fixed moment arm 119 as disclosed in the detailed description of FIG. 12.

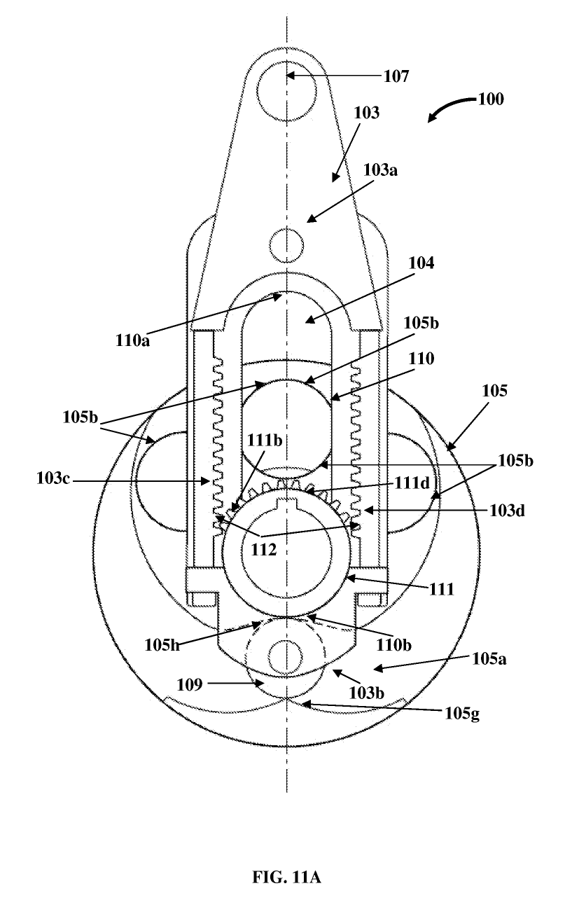

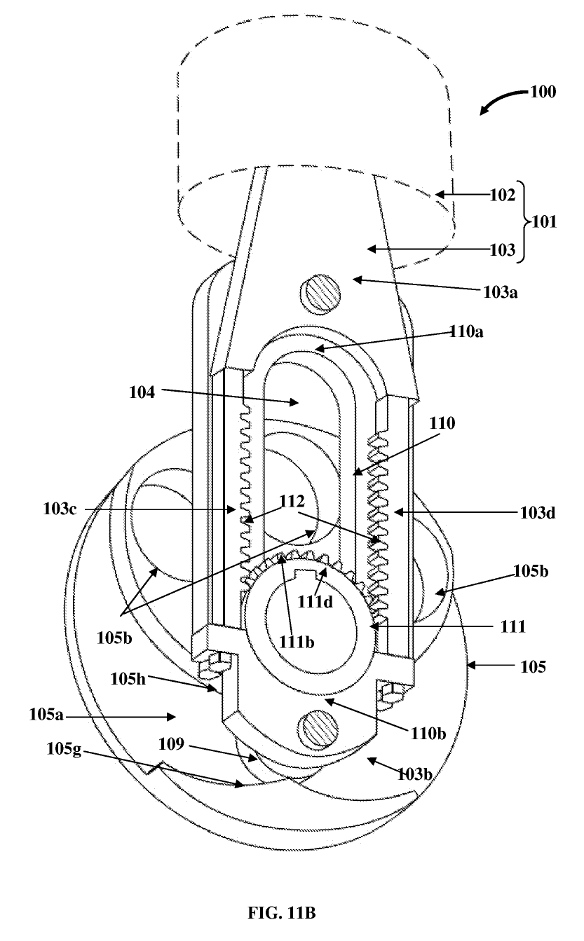

FIG. 11A and FIG. 11B exemplarily illustrate an orthogonal view and a perspective view of the fixed moment arm internal gear drive apparatus 100 respectively, when the piston 102 is at the top dead center 118a within the engine housing 118. As one stroke of the piston 102 from the bottom dead center 118b to the top dead center 118a is complete, the segmented gear 111 is at the bottom end 110b of the elongated aperture 110 of the reciprocating rod 103. The curvedly shaped walls 105g and 105h of the profiled grooves 105a of the transfer plates 105 contact the followers 109 rigidly connected to the reciprocating rod 103, when the piston 102 is at the top dead center 118a. The segmented gear 111 transmits the rotary motion to the transfer plates 105 for rotating the transfer plates 105. One of the followers 109 at the other opposing end 103b of the reciprocating rod 103 rotatably contacts the first curvedly shaped wall 105g and the second curvedly shaped wall 105h of the profiled grooves 105a of the transfer plates 105, when the piston 102 is at the top dead center 118a to control transition of the reciprocating assembly 101. The profile grooves 105a on the transfer plates 105 enable smooth transition of the segmented gear 111 from the internal gear racks 112 on one opposing internal side 103c of the reciprocating rod 103 to the internal gear racks 112 on the other opposing internal side 103d of the reciprocating rod 103 to begin the next stroke of the piston 102 from the top dead center 118a to the bottom dead center 118b.

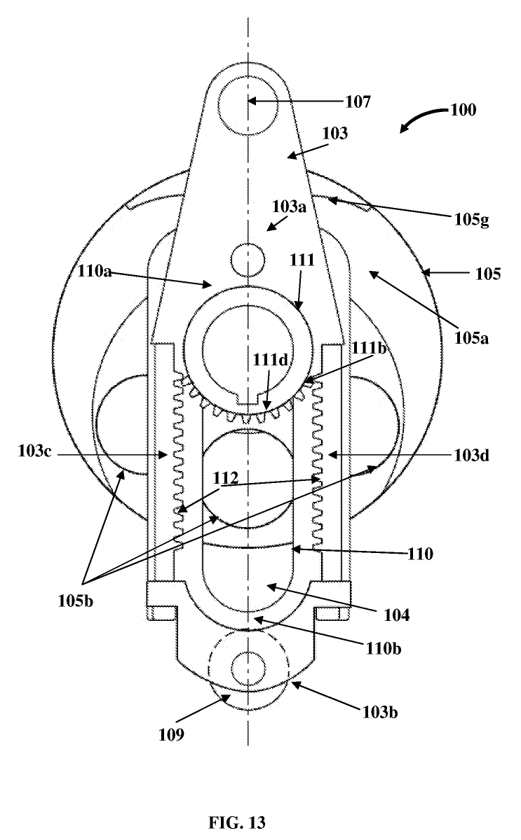

FIG. 12 exemplarily illustrates an orthogonal view of the fixed moment arm internal gear drive apparatus 100, when the piston 102 is traversing from the top dead center 118a to the bottom dead center 118b within the engine housing 118. During this stroke of the piston 102, the segmented gear 111 meshes with the internal gear racks 112 on the other opposing internal side 103d of the reciprocating rod 103. As the piston 102 moves downwards, the internal gear racks 112 disposed on the opposing internal side 103d of the reciprocating rod 103 engages with the gear teeth 111b on the partial gear area 111d of the segmented gear 111 that transmits power to the power shaft 106. As this stroke of the piston 102 is complete, the segmented gear 111 reaches the top end 110a of the elongated aperture 110 of the reciprocating rod 103 as exemplarily illustrated in FIG. 13 and the process repeats. In this way, a linear reciprocating motion of the reciprocating rod 103 is converted to a rotary motion of the segmented gear 111, which is then transferred to the power shaft 106 via the transfer plates 105.

When the segmented gear 111 rotates, a moment arm is produced by a combined effort of a radial force and a tangential force generated during rotation of the segmented gear 111. Rotation of the segmented gear 111 generates a force that is tangential to the segmented gear 111 along a line of action 120 of the reciprocating rod 103. The line of action 120 represents a linear motion of the reciprocating rod 103 during operation. The fixed moment arm 119 is achieved through the interaction between the segmented gear 111 and each of the internal gear racks 112. As the segmented gear 111 rotates and engages with the internal gear racks 112, the tangential force generated remains constant as the piston 102 traverses from the top dead center 118a to the bottom dead center 118b and vice versa, and causes the rotation of the power shaft 106.

FIG. 13 exemplarily illustrates an orthogonal view of the fixed moment arm internal gear drive apparatus 100, when the piston 102 is at the bottom dead center 118b within the engine housing 118. When the piston 102 is at the bottom dead center 118b, the segmented gear 111 is at the top end 110a of the elongated aperture 110 of the reciprocating rod 103 as disclosed in the detailed description of FIGS. 9A-9B.

The fixed moment arm internal gear drive apparatus 100 disclosed herein comprises a fixed stroke length of the piston 102, for example, a two-inch stroke length, for which a fixed moment arm 119 exists, for example, a 0.633-inch moment arm. In the fixed moment arm internal gear drive apparatus 100 disclosed herein, a mixture of fuel and air is ignited in the engine housing 118 and a combustion force is produced as a result of the ignition of the mixture of fuel and air. This combustion force is transmitted, with its maximum magnitude, to the power shaft 106, thereby increasing efficiency by approximately 93 percent for a two-inch stroke length as disclosed below.

The fixed moment arm internal gear drive apparatus 100 disclosed herein using a two-inch stroke length develops a fixed moment arm 119. For a 2″ stroke length, the circumferences 111h of the segmented gear 111, as exemplarily illustrated in FIG. 2, must be a working 4″, thereby creating a working diameter of 1.27″ for the segment gear 111. By dividing the working diameter by two, about 0.633″ fixed moment arm 119 is obtained. This fixed moment arm 119 yields approximately a 93% increase in power output and torque of the fixed moment arm internal gear drive apparatus 100 by evaluating the percentage change in moment arm length, 0.3″, over the original moment arm length 0.33″ of a conventional reciprocating engine.

Hence, the fixed moment arm internal gear drive apparatus 100 having a two-inch stroke length is approximately 93% more efficient compared to the conventional reciprocating engine having the same stroke length. Alternatively, the fixed moment arm internal gear drive apparatus 100 can be reduced in size by approximately 93% when compared to the 2″ stroke length conventional reciprocating engine for the same power output. The fixed moment arm internal gear drive apparatus 100 disclosed herein is retrofitable to different engine configurations, for example, a single cylinder configuration, a dual cylinder configuration, a vee engine configuration, etc., and to engines operating on different cycles, for example, a four stroke, a two stroke, Otto, diesel, etc. The fixed moment arm internal gear drive apparatus 100 disclosed herein is applicable to all types of piston-operated devices, for example, four cycle, two cycle, and diesel engines, for pump and motor applications, etc.

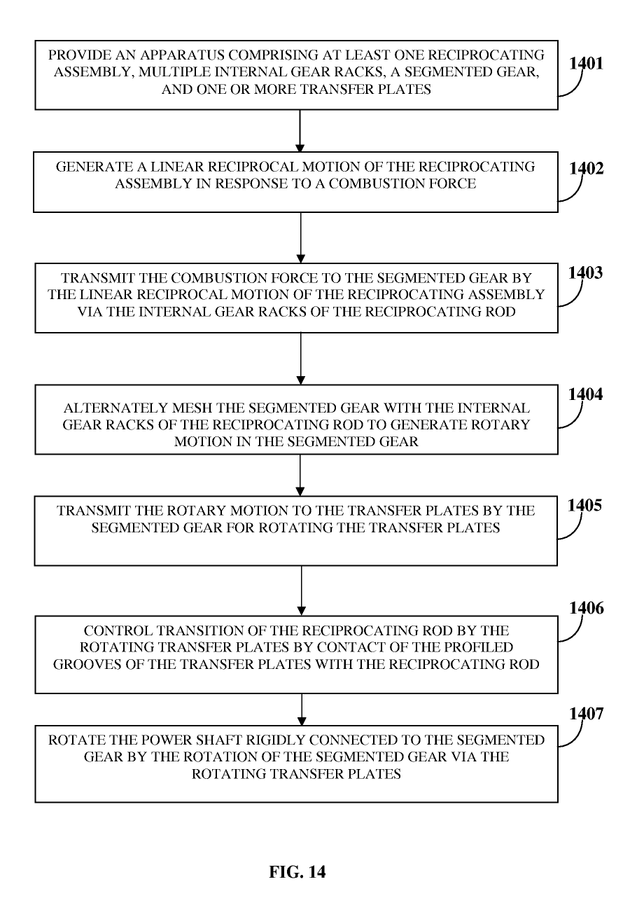

FIG. 14 illustrates a method for converting linear reciprocal motion to rotary motion. The fixed moment arm internal gear drive apparatus 100 comprising at least one reciprocating assembly 101, multiple internal gear racks 112, a segmented gear 111, and one or more transfer plates 105 as disclosed in the detailed descriptions of FIGS. 1-13 is provided 1401. The reciprocating assembly 101 comprising a reciprocating component 102 and a reciprocating rod 103 are capable of a linear reciprocal motion in unison. A linear reciprocal motion of the reciprocating assembly 101 is generated 1402 in response to a combustion force produced by ignition of the mixture of fuel and air in the engine housing 118. The linear reciprocal motion of the reciprocating assembly 101 transmits 1403 the combustion force to the segmented gear 111 via the internal gear racks 112 of the reciprocating rod 103. The segmented gear 111 alternately meshes 1404 with the internal gear racks 112 on the opposing internal sides 103c and 103d of the reciprocating rod 103 to generate rotary motion in the segmented gear 111. The segmented gear 111 transmits 1405 the rotary motion to the transfer plates 105 rigidly connected and timed to the segmented gear 111 for rotating the transfer plates 105. The transfer plates 105 assist and facilitate smooth alternate meshing of the segmented gear 111 with the internal gear racks 112 of the reciprocating rod 103.

The rotating transfer plates 105 control 1406 the transition of the reciprocating rod 103 by contact of the profiled grooves 105a of the transfer plates 105 with the reciprocating rod 103, when the reciprocating component 102 is at the top dead center 118a and the bottom dead center 118b within the engine housing 118. The curvedly shaped walls 105g and 105h of the profiled grooves 105a contact one or more followers 109 rigidly connected to the opposing ends 103a and 103b of the reciprocating rod 103, when the reciprocating component 102 is at the top dead center 118a and the bottom dead center 118b for controlling transition of the reciprocating rod 103. The rotation of the segmented gear 111 rotates 1407 the power shaft 106 rigidly connected to the segmented gear 111 via the rotating transfer plates 105, thereby generating rotary motion of the power shaft 106. The centric axis 114 of the segmented gear 111 is collinear to the longitudinal axis 113 of the power shaft 106 during operation of the fixed moment arm internal gear drive apparatus 100. The transfer plates 105 are stabilized using one or more balancing reliefs 105b defined along a circumference 105d of each of the transfer plates 105.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. An apparatus for converting linear reciprocal motion to rotary motion, comprising:
at least one reciprocating assembly comprising a reciprocating component and a reciprocating rod capable of said linear reciprocal motion in unison, wherein said reciprocating component is rigidly attached to said reciprocating rod along a vertical axis of said reciprocating rod, and wherein said reciprocating component is supported in an engine housing;
a plurality of internal gear racks disposed on opposing internal sides of said reciprocating rod for inducing rotary motion in a segmented gear by said linear reciprocal motion of said reciprocating rod, wherein said segmented gear is in alternate mesh with said internal gear racks rigidly attached on said opposing internal sides of said reciprocating rod;
said segmented gear disposed within a space defined between said opposing internal sides of said reciprocating rod and rigidly connected to a power shaft, wherein said segmented gear alternately meshes with said internal gear racks on said opposing internal sides of said reciprocating rod to transmit said rotary motion of said segmented gear to said power shaft, wherein said segmented gear and each of said internal gear racks together define a fixed moment arm; and
one or more transfer plates coaxially disposed on a centric axis of said segmented gear and rigidly connected to said power shaft, wherein each of said one or more transfer plates comprises one or more profiled grooves for controlling transition of said reciprocating rod by contacting said reciprocating rod, when said reciprocating component is at a top dead center and a bottom dead center within said engine housing, and wherein said segmented gear transmits said rotary motion to said one or more transfer plates rigidly connected and timed to said segmented gear for rotating said one or more transfer plates;
whereby said rotary motion of said segmented gear converts said linear reciprocal motion of said reciprocating assembly to rotary motion of said power shaft.

2. The apparatus of claim 1, wherein said centric axis of said segmented gear is collinear to a longitudinal axis of said power shaft.

3. The apparatus of claim 1, wherein said segmented gear comprises a partial gear area on a surface of said segmented gear, wherein said partial gear area on said surface of said segmented gear is in said alternate mesh with one of said internal gear racks on one of said opposing internal sides of said reciprocating rod.

4. The apparatus of claim 1, wherein said power shaft is rotatably supported in said engine housing.

5. The apparatus of claim 1, wherein said internal gear racks of said reciprocating rod and said segmented gear are constructed in one of a spur gear configuration, a helical gear configuration, and a herringbone gear configuration.

6. The apparatus of claim 1, wherein said reciprocating component is a piston.

7. The apparatus of claim 1, wherein said reciprocating rod comprises an elongated aperture along said vertical axis of said reciprocating rod, wherein said elongated aperture defines said space between said opposing internal sides of said reciprocating rod for accommodating said segmented gear.

8. The apparatus of claim 1, wherein said one or more transfer plates assist and facilitate smooth said alternate meshing of said segmented gear with said internal gear racks of said reciprocating rod.

9. The apparatus of claim 1, further comprising one or more followers rigidly connected to opposing ends of said reciprocating rod for following said rotary motion of said one or more transfer plates, wherein said one or more followers rotatably contact said one or more profiled grooves of said one or more transfer plates, when said reciprocating component is at said top dead center and said bottom dead center within said engine housing.

10. The apparatus of claim 9, wherein said one or more profiled grooves of said one or more transfer plates comprise curvedly shaped walls for contacting said one or more followers rigidly connected to said opposing ends of said reciprocating rod, when said reciprocating component is at said top dead center and said bottom dead center within said engine housing.

11. The apparatus of claim 1, further comprising a keyway defined on an inner periphery of a central opening of each of said segmented gear and said one or more transfer plates, wherein said power shaft is inserted into said central opening of said each of said segmented gear and said one or more transfer plates and locked to said segmented gear and said one or more transfer plates through said keyway.

12. The apparatus of claim 1, wherein said one or more transfer plates further comprise one or more balancing reliefs defined along a circumference of said one or more transfer plates for stabilizing said one or more transfer plates.

13. The apparatus of claim 1, wherein each of said internal gear racks is one of integrated on said opposing internal sides of said reciprocating rod and internally attached to said opposing internal sides of said reciprocating rod.

14. A method for converting linear reciprocal motion to rotary motion, comprising:
providing an apparatus comprising:
at least one reciprocating assembly comprising a reciprocating component and a reciprocating rod capable of said linear reciprocal motion in unison, wherein said reciprocating component is rigidly attached to said reciprocating rod along a vertical axis of said reciprocating rod, and wherein said reciprocating component is supported in an engine housing;
a plurality of internal gear racks disposed on opposing internal sides of said reciprocating rod for inducing rotary motion in a segmented gear by said linear reciprocal motion of said reciprocating rod;
said segmented gear disposed within a space defined between said opposing internal sides of said reciprocating rod and rigidly connected to a power shaft, wherein said segmented gear is configured to alternately mesh with said internal gear racks rigidly attached on said opposing internal sides of said reciprocating rod to transmit said rotary motion of said segmented gear to said power shaft, said power shaft being rotatably supported in said engine housing, wherein said segmented gear and each of said internal gear racks together define a fixed moment arm; and
one or more transfer plates coaxially disposed on a centric axis of said segmented gear and rigidly connected to said power shaft, wherein each of said one or more transfer plates comprises one or more profiled grooves configured for contacting said reciprocating rod, when said reciprocating component is at a top dead center and a bottom dead center within said engine housing;
generating said linear reciprocal motion of said reciprocating assembly in response to a combustion force;
transmitting said combustion force to said segmented gear by said linear reciprocal motion of said reciprocating assembly via said internal gear racks on said opposing internal sides of said reciprocating rod, wherein said segmented gear alternately meshes with said internal gear racks on said opposing internal sides of said reciprocating rod to generate rotary motion in said segmented gear, wherein said segmented gear transmits said rotary motion to said one or more transfer plates rigidly connected and timed to said segmented gear for rotating said one or more transfer plates;
controlling transition of said reciprocating rod by said rotating one or more transfer plates by contact of said one or more profiled grooves of said one or more transfer plates with said reciprocating rod, when said reciprocating component is at said top dead center and said bottom dead center within said engine housing; and
rotating said power shaft rigidly connected to said segmented gear by said rotation of said segmented gear, via said rotating one or more transfer plates;
whereby rotary motion is generated in said power shaft.

15. The method of claim 14, wherein said segmented gear comprises a partial gear area on a surface of said segmented gear, wherein said partial gear area on said surface of said segmented gear is in said alternate mesh with one of said internal gear racks on one of said opposing internal sides of said reciprocating rod.

16. The method of claim 14, wherein a centric axis of said segmented gear is collinear to a longitudinal axis of said power shaft during operation of said apparatus.

17. The method of claim 14, wherein said reciprocating rod comprises an elongated aperture along said vertical axis of said reciprocating rod, wherein said elongated aperture defines said space between said opposing internal sides of said reciprocating rod for accommodating said segmented gear.

18. The method of claim 14, wherein said one or more transfer plates assist and facilitate smooth said alternate meshing of said segmented gear with said internal gear racks of said reciprocating rod.

19. The method of claim 14, wherein said apparatus further comprises one or more followers rigidly connected to opposing ends of said reciprocating rod for following said rotary motion of said one or more transfer plates, wherein said one or more followers rotatably contact said one or more profiled grooves of said one or more transfer plates, when said reciprocating component is at said top dead center and said bottom dead center within said engine housing.

20. The method of claim 19, wherein said one or more profiled grooves of said one or more transfer plates comprise curvedly shaped walls for contacting said one or more followers rigidly connected to said opposing ends of said reciprocating rod, when said reciprocating component is at said top dead center and said bottom dead center within said engine housing.

21. The method of claim 14, further comprising locking said power shaft to each of said segmented gear and said one or more transfer plates through a keyway defined on an inner periphery of a central opening of said each of said segmented gear and said one or more transfer plates.

22. The method of claim 14, further comprising stabilizing said one or more transfer plates using one or more balancing reliefs defined along a circumference of said one or more transfer plates.
